(19) United States
(12) Patent Application Publication
(10) Pub. No.: US 2025/0165818 A1
(43) Pub. Date: May 22, 2025

(54) Side-Channel Aware Training for Commercial Machine Learning Accelerators

(71) Applicant: North Carolina State University, Raleigh, NC (US)

(72) Inventors: Anuj Dubey, Raleigh, NC (US); Aydin Aysu, Raleigh, NC (US)

(21) Appl. No.: 18/950,948

(22) Filed: Nov. 18, 2024

Related U.S. Application Data
(60) Provisional application No. 63/600,312, filed on Nov. 17, 2023.

(51) Int. Cl. G06N 5/04

(52) U.S. Cl. CPC G06N 5/04

(57) ABSTRACT

Various examples are provided related to side-channel awareness. In one example, a method for side-channel awareness training includes generating trained models by stochastically training neural network models using a common training dataset; generating an inference model based upon random selection of parameters from one or more of the trained models; and training the inference model with the selected parameters. The trained inference model can be executed on an edge Tensor Processing Unit (TPU). The models can be trained offline. An input signal can be processed using the trained inference model to generate an output signal for transmission.

### CROSS REFERENCE TO RELATED APPLICATIONS

This application claims priority to, and the benefit of, U.S. provisional application entitled “Side-Channel Aware Training for Commercial Machine Learning Accelerators” having Ser. No. 63/600,312, filed Nov. 17, 2023, which is hereby incorporated by reference in its entirety.

### STATEMENT REGARDING FEDERALLY SPONSORED RESEARCH OR DEVELOPMENT

This invention was made with government support under grant numbers CCF2146881 and CNS1943245 awarded by the National Science Foundation. The government has certain rights in the invention.

### BACKGROUND

The current machine learning (ML) ecosystem is quite mature already and various commercial accelerators are circulating from prominent industry players such as Google, and NVIDIA. These accelerators are usually shipped with a software toolkit that enables end-to-end model development and subsequent deployment of models on their products. Specifically, the toolkits provide easy APIs to develop an ML application and a compiler that can generate the executable to run on hardware.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate examples of regular neural network training and inference and multi-model training and inference, in accordance with various embodiments of the present disclosure.

FIG. 2 illustrates an example of an if-else construct using an ReLU operation, in accordance with various embodiments of the present disclosure.

FIGS. 3 and 4 illustrate examples of side-channel test results, in accordance with various embodiments of the present disclosure.

FIG. 5A is a schematic block diagram illustrating an example of a processing or computing device that can be used for implementation of side-channel awareness training, in accordance with various embodiments of the present disclosure.

FIG. 5B is a flow chart or diagram illustrating an example of the side-channel awareness training of FIG. 5A, in accordance with various embodiments of the present disclosure.

### DETAILED DESCRIPTION

Disclosed herein are various examples related to side-channel awareness. Providing side-channel security in existing commercial accelerators is a challenging problem. The various constraints presenting an already existing commercial accelerator coupled with proprietary software stacks make it difficult to implement side-channel countermeasures. Reference will now be made in detail to the description of the embodiments as illustrated in the drawings, wherein like reference numbers indicate like parts throughout the several views.

As a case study, Google's Edge Tensor Processing Unit (TPU) was chosen as a target platform (Goo22a). The Edge TPU is Google's purpose-built ASIC designed to deliver high-performance inferencing for mobile and IoT devices. An in-depth analysis of the software ecosystem was performed around it, and the available hardware resources on-chip considering the threat of physical side channels. Based on the analysis, a novel countermeasure is proposed that can provide side-channel resistance without requiring any changes in the hardware, or the software toolkit. A fundamental property of machine learning algorithms is identified that is not present in cryptographic algorithms, which can be effectively used as an entropy source for side-channel countermeasures. Indeed, analyzing the differences in machine learning and cryptographic implementations paves a way for efficient side-channel security solutions for ML applications.

The Edge TPU in the current version primarily supports inference, with small support for transfer learning only for the final layer. Since the trained model is assumed to be already deployed on the device in the threat model, the focus will be on secure inferencing for the scope of this disclosure. Currently, there exist many software frameworks for ML model development. Tensorflow, and Pytorch are two leading ML frameworks to this end developed by Google, and Facebook, respectively (Goo22c;Met22a). Both frameworks have an extension targeted specifically for low-end mobile/IoT devices called PytorchMobile, and Tensorflow Lite (Met22b; Goo22d). The Coral's Edge TPU currently only supports Tensorflow Lite (TFLite). While the discussion is limited to TFLite, it is applicable to both.

### Introduction to Tensorflow and TFLite

Tensorflow. Tensorflow is an open-source ML library specifically designed to create high-performance ML applications. The frontend code can be developed using any language like Python, C, Javascript, etc., by the user. The backend of the library is implemented using C++, which is highly optimized to perform numerical computations on a variety of hardware such as CPU, GPU, TPU, etc. The backend also uses other libraries like Eigen, and CuDNN, which are developed for accelerated computing on NVIDIA GPUs. Tensorflow is different in two aspects compared to traditional programming languages like C, C++, Python, etc. First, tensor is the basic unit of computation. Tensor is a multi-dimensional array, which is more suitable for operations in machine learning, which require processing multiple data units through the same functions repeatedly—data units are packed as a single tensor.

The second aspect of Tensorflow is support for graph-based execution, which is a different programming model than that of languages like Python that instantly evaluate functions and produce the output (also called eager execution). In a graph-based execution, the functions are first expressed as a graph, where each node signifies an operation over tensors. The graph is later used during runtime over the data that flows through the edges of the graph as tensors—user can just run the entire code as one unit. Storing the computations as graphs increase the performance of the code (latency) because no time is spent analyzing the code during runtime—it directly executes the operations of the graph over the input data. Expressing computations as graphs also assists in various compiler optimizations like constant folding, parallel computation on multiple devices/threads, reducing peak memory usage, etc.

The trained model parameters along with the frozen graph representing neural network architecture can be stored in a special file format called protobuf (has .pb extension). The protobuf file can then be used for inference over any input data set. Eager execution, however, is more intuitive and better during the development phase of an application. One key benefit is easy debugging because the individual function outputs are observable and can be probed instantly. Tensorflow 1, and Tensorflow 2 are the two currently available versions of Tensorflow. The former only supports graph-based execution, whereas the latter has a provision to support both (the default is eager execution).

TFLite. TFLite is an extension of the Tensorflow library that was released by Google to specifically target mobile and embedded platforms. Since these devices are constrained in memory and compute resources, the library uses various optimizations to reduce the memory footprint and computational requirements. TFLite is primarily designed for inference; a trained Tensorflow model in protobuf format can be converted to a TFLite format and then deployed on an embedded device. Since TFLite is a reduced version of Tensorflow, it imposes certain restrictions on the data type and the operations to be used in the model to be converted. For instance, TFLite supports 32-bit floating point numbers, and 8-bit signed and unsigned integer data types, but not 16-bit floating point numbers. Thus, the user should ensure that the data type and operators used in the original model are also compatible with TFLite, otherwise, the conversion will fail, or produce unexpected results. The TFLite file has a different format called flatbuffer instead of the originally compiled protobuf format by Tensorflow.

One of the key advantages of flatbuffers over protobuf is time savings in parsing and serializing the data; the data in flatbuffers is already serialized through efficient use of indirections and data structures. TFLite also supports hardware acceleration through the Delegate API (Goo22e), which is an interface between TFLite and the APIs of other hardware accelerators from Qualcomm, NVIDIA, or Google's own Edge TPU. TFLite also supports quantization of ML models. ML model parameters are generally trained with a 32, or 64-bit floating point precision, which is expensive for embedded devices. Quantization is a technique to reduce the precision of the trained model parameters with a small loss of accuracy. Overall, TFLite is a complete library that allows one to efficiently deploy models built using Tensorflow to a variety of available hardware platforms. We will now focus on the deployment of ML models to the Edge TPU. After the model is trained in Tensorflow, and converted to TFLite, it can be compiled specifically for the Edge TPU. Google provides a proprietary edgetpu-compiler for this process.

### Edge TPU Compiler

The edgetpu-compiler is a command-line tool released by Google to compile TFLite files for the Edge-TPU. It is currently only supported on a Debian-based Linux operating system and a 64-bit x86 processor. Users can also upload their TFLite models on Google Colab, and use the web-based edgetpu-compiler. Since the compiled model is supposed to run on the Edge TPU, the compiler imposes further restrictions on the type of operations and data types to be used in the model to successfully map all the operations to the available hardware resources on the Edge TPU.
All the tensors used in the model should be quantized to 8 bits.
The sizes of the tensors should be constant at compile-time.
The model should only use the supported operations listed in the official documentation.

The compiler supports most of the traditional neural network operations like matrix multiplication, ReLU, sigmoid, etc., which makes it suitable to run any deep feed-forward, or convolutional neural network efficiently. An important point is that it lacks support for instructions that change the control flow, unlike a traditional processor. Thus, implementing conditional constructs like the “if-else” is not possible in the Edge TPU. This is because the design goal for the Edge TPU is to perform high-performance neural network inference, which does not have these complex constructs. Next, the hardware architecture of the TPU is discussed, which is the basis for the architecture of the Edge TPU.

### Google TPU Hardware Architecture

The exact hardware architecture of the edge TPUs is currently not public. However, it is speculated to follow the same architecture as that of the cloud TPUs, with differences in the number of multiply-accumulate units used in the systolic array. The cloud TPU is mainly designed to parallelly execute a large number of neural network-specific operations with low latency. This can be achieved by instantiating multiple compute units like adders, multipliers, activation functions, etc., that can simultaneously execute independent neural network operations. A large matrix-multiply unit, which is based on the systolic array style of computing, can be used. A systolic array is a dense network of processing elements (PE) arranged in a certain fashion to enable extremely low-latency computations over a large amount of data. Unlike a traditional von Neumann or Harvard architecture that has frequent memory transfers from the compute units, in a systolic array the PEs directly feed the results to other PEs and avoid long-latency memory transfers resulting in huge performance gains. The systolic array feeds the summations to the activation units, which eventually compute the final neuron values of the layer. Since the TPU is primarily an arithmetic unit, it might lack the hardware support for complicated control flow instructions such as branch or jump instructions. Given that the edge TPU is a scaled-down version of the cloud TPU that typically targets embedded applications, there is an even higher chance for the control flow hardware to be absent.

### Side-Channel Countermeasure for TPUs

Traditional power/EM side-channel defenses for cryptographic algorithms either propose to implement techniques such as masking or hiding. The hardware of the TPU will certainly not change. Regarding software, the edgetpu-compiler is proprietary and directly generates an executable; there is no provision to emit out any intermediate instructions. Thus, countermeasures like the shuffling of instructions cannot be implemented. Thus, only the source code of the neural network that we deploy on the Edge TPU can be controlled. Here, a novel technique is proposed to reduce the side-channel leakage in an Edge TPU that does not require modifying the hardware, or the compiler stack.

### Deep-Dive into Neural Network Training

A neural network is first trained using a representative dataset (also called the training dataset). The training process for neural networks is described in more detail here as it forms the basis for the proposal.

Loss Functions. The loss function quantifies how distant is the prediction of the neural network from the correct prediction (also called ground truth)—it is high when the model accuracy is low, and low when the model accuracy is high. Mean squared error (MSE), and categorical cross-entropy loss are commonly used loss functions for regression, and classification tasks, respectively. Since we mainly focus on classification, we will discuss the categorical cross-entropy loss function L(.) next. In the case of binary classification with just two labels 0 and 1, L(.) is defined as follows.

$$L ( {\hat{y}}_{i} , {y}_{i} ) = - {y}_{i} \times log ( {\hat{y}}_{i} ) + ( 1 - {y}_{i} ) \times log ( 1 - {\hat{y}}_{i} )$$

$${\hat{y}}_{i} = model ( {x}_{i} , W , B )$$

yᵢ is the correct label (either 0 or 1), and ŷᵢ is the predicted probability by the model for label 1 (confidence scores at the output layer are often interpreted as probabilities for the respective classes). Note that L is designed to be high if the model output ŷᵢ is low (close to 0) for an input corresponding to label 1 and vice versa. Due to the logarithmic variation, the loss is much higher for incorrect predictions, i.e., if the model predicts lower probabilities for label 1.

The overall loss for a training step is actually the average loss

$$\frac{1}{m} {\sum }_{m = 0}^{m - 1} L ( {\hat{y}}_{i} , {y}_{i} )$$

over all the m training samples xᵢ. For multiple classes, L(.) can be generalized to the following equation.

$$L ( {\hat{y}}_{i} , {y}_{i} ) = {\sum }_{c = 0}^{N - 1} ( - {y}_{ic} \times log ( \hat{{y}_{ic}} ) )$$

Here c represents the output class. ŷ_{i,c} is a function of the input sample xᵢ, and the model weights W and biases B (model weights and biases are variable during training, but fixed during inference). W and B can be randomly initialized at the start of the training process. Training is essentially an optimization problem, where the objective is to minimize the loss function, i.e., to find the values of W and B such that the loss is minimized.

Backpropagation. Algorithm 2 lists a typical sequence of steps executed during training. All the training samples and the corresponding labels are condensed into matrices X and Y, respectively. Each step performs a forward pass and a backward pass. Lines 6-7 perform the forward pass, which is simply the act of evaluating the model function for training samples X, W, and B. The algorithm computes the cumulative loss L using the evaluated output Zₙ from the model, and the true labels Y. Differentiation (or finding derivative) is a well-known technique in calculus to find the minimum or the maximum value of a given function. The technical term gradient is used instead of derivative henceforth since L is a multi-variable function. The gradient of a function f with respect to an input variable v is notated as Δᵥf. It signifies the direction of greatest change for that function with respect to v.

Algorithm 2 Neural Network Training

| 1: | procedure GRADIENT DESCENT(X,N ,Y,α, Eₚ, n) |
|---|---|
| input: X,N ,Y,α,Eₚ,n | |
| output: W, B | |
| 2: | W ← random( ) |
| 3: | B ← random( ) |
| 4: | for i = 1 ... Eₚ do |
| 5: | Z₀ ← X |
| 6: | for j = 1 ... n do |
| 7: | Zⱼ₊₁ ← layerⱼ(Zⱼ, Wⱼ, Bⱼ) |
| 8: | for j = 1 ... n do |
| 9: | Wⱼ ← Wⱼ − αΔ_{W}_{ⱼ} L(Zₙ_{, Y)} |

The training algorithm computes the gradients Δ_{W}L and Δ_{B}L. Since the goal is to minimize L, the algorithm updates the W and B variables as W−α×Δ_{W}L, and B−α×Δ_{B}L, where α is called the learning rate. The learning rate controls the amount by which the model descends in each step and requires some initial tuning. This process of updating the weights and biases of the neural network by computing gradients all the way from the loss function computed over the output nodes to the input layer is called backpropagation, or backward pass. Lines 8-9 perform backpropagation by updating W and B. Thus, the newly updated model function now has a loss lesser than what it was before the training step, or equivalently has become more accurate. The training algorithm continues this process multiple times until the model accuracy reaches the desired level. The steps are also called epochs, and Eₚ defines the total number of epochs in training. The entire process is popularly called gradient descent because in each step the model is descending down the loss function curve towards a minimum by computing gradients.

Stochastic Minibatch Gradient Descent. Performing the gradient descent over the entire dataset is too expensive computationally, and thus, prior works suggest an alternate approach called the stochastic minibatch gradient descent. The training samples are split into smaller batches and each step only trains over that batch. This, however, causes higher variation in model updates since one batch does not fully represent the features of the entire training dataset. The computational benefits and an insignificant change in accuracy make it a favorable choice in the current literature. The technique also proposes to randomly sample batches from the training dataset—making it stochastic in nature, to remove any biases that might exist in the ordering of the training dataset. Furthermore, a neural network is a complicated multivariable function, which can have multiple minima. Thus, based on the initialized values of parameters, and the sampled batches, the model might not exactly converge to the same minima for two separate training executions. The trained weights and biases can be different but still provide almost similar accuracy. Next, how the stochastic behavior of learning can be used in neural networks to effectively architect a side channel defense will be discussed.

### Multi-Model Training

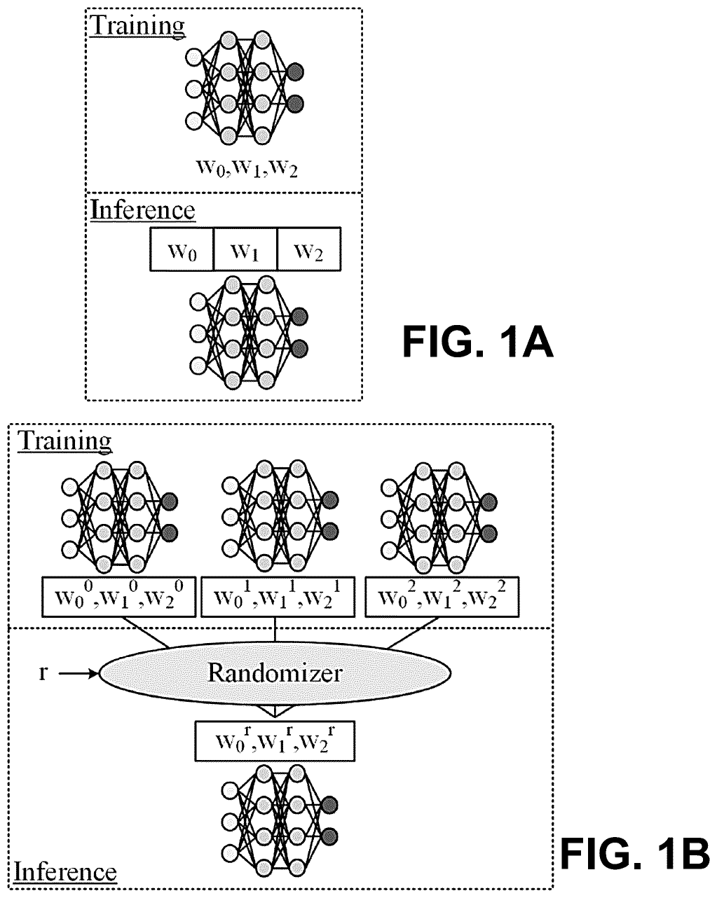

Referring to FIGS. 1A and 1B, shown are examples illustrating an overview of the side-channel defense. FIG. 1A depicts a regular neural network training and inference phase. The model is trained over a dataset, and the trained model parameters are used during inference. FIG. 1B depicts the proposed multi-model training and inference, which can yield side-channel resistance benefits without losing significant accuracy. During training, multiple models can be trained with the same training dataset. Due to the stochastic nature of training, the trained model parameters will differ for each trained model. Once the multiple trained models are trained with different parameters, two related solutions are proposed for the defense.

Secure forward pass. In the first solution, the model randomly selects all the parameters of one of the trained models for each inference. The basis of any vertical side-channel attack is to target an intermediate computation between a known value and the secret and relies on the fact that the computation happens at the same time in each measurement. Shuffling breaks the second assumption because the same computation does not happen at the same time in each measurement. Similarly, in the proposed defense, the inputs and all the intermediate values will be processed with a different set of parameters in each execution and make the inference side-channel resistant. The side-channel security can be increased by training more models and increasing the number of random choices during inference.

Secure forward and backward pass. One limitation of the first approach is that the amount of randomness during inference linearly depends on the number of trained models. This can be improved in the second solution. The difference in the second solution is that the random choice of parameters happens at the granularity of layers instead of models. Thus, during inference, the model now chooses the parameters for each layer randomly from the parameters of that layer from one of the trained models. This increases the number of possibilities during inference compared to the first solution. For instance, for a two-layer neural network, and two trained models, the inference can now create four model choices instead of two.

A preliminary investigation to test this idea was carried out and it was observed that directly replacing the layer weights between multiple models can result in a huge accuracy loss as shown in Table 1 below. This is because the parameters of each layer in a trained model were trained only with respect to the parameters of the other layers in the same model. Changing the parameters randomly during the inference drastically changes the trained function, and thus, it does not behave the way it was during training. To address this problem, a new training algorithm can be used to incorporate the information about the parameters of the other models in the training. The key idea is to incorporate the random layer choice also during backpropagation.

TABLE 1
Accuracy results with direct swapping of layer weights across models.

| Model | W1 | W2 | Accuracy(%) |
|---|---|---|---|
| Model-1 | 0 | 0 | 90.63 |
| Model-2 | 0 | 1 | 11.74 |
| Model-3 | 1 | 0 | 13.15 |
| Model-4 | 1 | 1 | 91.64 |

Algorithm 3 describes the randomized backpropagation. The number of choices for each layer is equal to the number of models to be trained for the countermeasure. This is denoted by m in the algorithm. At the start of each epoch, the algorithm uniformly and randomly samples the choice of parameters for each layer between 1 . . . m (lines 2-4). The parameters of different models are distinguished using superscripts. Since the inference can make a different choice for each input, different choices are sampled for each training sample to preserve the behavior of the model. Thus, the algorithm samples a different set of layer choices for each element xᵢ of X.

Algorithm 3 Randomized Backpropagation

| 1: | procedure GRADIENT DESCENT(X,N ,Y,α, Eₚ, n, m) |
|---|---|
| input: X,N ,Y,α,Eₚ,n | |
| output: W, B | |
| 2: | for k = 1 ... m do |
| 3: | W^{k} ← random({1 ... m}) |
| 4: | B^{k} ← random({1 ... m}) |
| 5: | for i = 1 ... Eₚ do |
| 6: | Z₀ ← X |
| 7: | for j = 1 ... n do |
| 8: | Zⱼ₊₁ ← layerⱼ(Zⱼ, Wⱼ^{r}^{ⱼ}, Bⱼ^{r}^{ⱼ}) |
| 9: | for j = 1 ... n do |
| 10: | Wⱼ^{r}^{ⱼ} ← Wⱼ^{r}^{ⱼ} − αΔ_{W}_{ⱼ}^{r}^{ⱼ} L(Zₙ, Y) |
| 11: | Bⱼ^{r}^{ⱼ} ← Bⱼ^{r}^{ⱼ} − αΔ_{B}_{ⱼ}^{r}^{ⱼ} L(Zₙ, Y) |

Next, the algorithm performs the forward pass using the chosen parameters for each layer and computes the final output Zₙ. Finally, the algorithm propagates the computed gradients only to the chosen parameters for that training sample. Running the algorithm over multiple epochs simultaneously keeps updating the parameters across multiple models with respect to each other. In a way, a larger model has now been trained which only uses a portion of itself in each inference, but still provides a reasonable accuracy. Implementation of the conditional selection in the forward pass is described next.

### Conditional Statements on Edge TPU

Next, consider how to implement the inference on the edge TPU. The training happens offline, but all the trained model parameters along with the network architecture are packed into one single model that runs on the edge TPU. Implementing the inference with random choices, however, is not trivial. Implementation of the randomizer shown in FIG. 1B involves conditional instructions. The network can first select parameters for each layer based on a random input provided, and then execute the layer computation using the chosen parameters. The second part involves computing the weighted summations and processing the activation function over the result, which is easy to implement. However, the first step of choosing the model parameters is not easy to implement on the edge TPU because it involves changing the control flow of the data. The edge TPU may lack hardware support for control flow instructions. The hypothesis was tested by compiling functions that change the control flow such as the if-else construct, and the tf.cond construct provided by the TensorFlow API. However, none of those programs successfully get compiled by the edgetpu-compiler, even though they worked fine when tested on the host CPU.

Thus, a fundamentally different approach was taken to implement the defense on the edge TPU that does not use any explicit control flow statements. To that end, all the supported operations on the edge TPU were explored and no operation was found that directly behaves like a conditional statement. Therefore, it was decided to construct one, using the available operations—taking a function that takes three inputs (a, b, r) and outputs one of the two inputs (a or b) based on the third input r. The rectified linear unit (ReLU) function is of particular interest here. It is defined as:

$$Re Lu ( x ) = \{ \begin{matrix}x , & x \geq 0 \\ 0 , & x < 0\end{matrix}$$

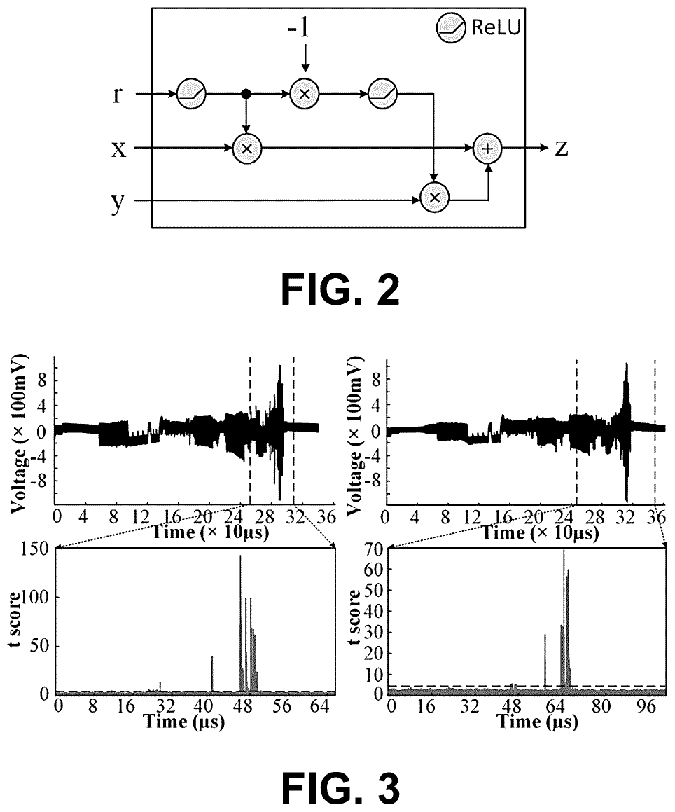

Indeed, the definition of this function has an if condition embedded in it that selects between either the input x or zero, based on the sign of x. If an r is randomly chosen between −1 and +1 and the output multiplied by some number x, the result will be x 50% of the time. That partially achieves the desired result—it selects a number based on a random input, but it also outputs a zero 50% of the time. To completely achieve the desired functionality, the same r can be multiplied with −1, and then the result can be multiplied with y. Now there are two mutually exclusive branches: one branch outputs x, and the other branch outputs a zero, or one branch outputs a zero and the other branch outputs y. The final step is to add both branches together. The result is x when r is +1, and y when r is −1. FIG. 2 graphically illustrates how to create an if-else construct using the ReLU operation.

Therefore, a novel function is constructed using only ReLU operations that behaves like an if-else construct. This function can be used to select between the different parameters from each model during inference on the edge TPU.

### Empirical Side-Channel Evaluation Methodology

Empirical security validation of hardware circuits relies on statistical evaluation of real power traces captured from the device when it executes the computation. Statistical evaluations can be either model-based such as the differential power analysis (DPA) (KJJ99a) that assumes a well-defined power model, or model-less such as the test vector leakage assessment (TVLA) (GGJR+11), which do make any assumptions on the power model and just detect information leakage.

DPA requires the adversary to know the implementation details and construct an appropriate power model. TVLA does not assume any power model and just detects information leakage by checking if the distribution of power traces for a fixed input is statistically indistinguishable from the distribution of the power traces for random inputs. TVLA uses Welch's t-test to detect the presence of side-channel leakage. Welch's t-test is used in statistics to test the hypothesis that two populations have similar means. The test computes a t-score that is given by the following equation.

$$t = \frac{{μ}_{fixed} - {μ}_{random}}{\sqrt{\frac{{σ}_{fixed}^{2}}{{N}_{fixed}} + \frac{{σ}_{random}^{2}}{{N}_{random}}}}$$

μ, σ₂, and N denote the mean, variance, and population size, respectively. The subscripts distinguish the fixed and random populations.

The leakage is considered statistically significant if the score crosses the threshold of ±4.5. No information leakage in a TVLA test implies no leakage in the DPA test too because the information is statistically insignificant for the DPA test to correlate. A high t-score results in the rejection of the null hypothesis that states that the two populations are drawn from the same distribution. A t-score crossing the threshold of ±4.5 implies a rejection of the null hypothesis with confidence of 99.99% and is the accepted threshold to experimentally detect the presence of side-channel leakage. The univariate non-specific fixed vs. random t-tests was chosen because it is independent of the underlying DUT implementation. TVLA may not be the best methodology for all possible cases (Sta18) but that it is a common technique used to evaluate the security of masking schemes (DAN+18; SEL21; SBM21). For power side-channel evaluation, the setup captures two sets of power traces: one in which the input is constant for all executions and one that varies the input per execution. The setup then computes the t-scores over these two sets. A high t-score implies that there is a side-channel leakage in the implementation because the power trace corresponding to a specific input (or fixed dataset) is distinguishable from the general population of power traces (or random dataset).

### Software-Only Countermeasures

This section presents the side-channel evaluation of the software countermeasures.

Measurement Setup. The target board is Coral's Dev Board, which is a development board that hosts the edge TPU on a removable system on module (SoM) (Goo20). Electromagnetic side channels were chosen for this evaluation to precisely capture the activity directly from the leaky points on the TPU. Riscure's high-sensitivity EM probe was used to capture the EM emanations from the TPU (Ris20). 1aThe EM Probe Station provided by Riscure which uses an XYZ table along with the EM probe was also used to spatially scan the chip for high EM activity. This is needed because the floorplan of the edge TPU has not been released. Based on the documentation of the Dev board, the edge TPU employs dynamic frequency scaling (DFS) to avoid overheating of the device. The default frequency of operation is 500 MHz, but it can change based on the temperature of the TPU. The setup first performs a spatial scan of the entire TPU chip while running inferences, and captures the EM activity at each point. Then a bandpass filter was used to find the subset of points that correspond to an EM activity at 500 MHz. The probe position was fixed to this location and the rest of the validation conducted.

Side Channel Validation. First, it was necessary to decide on the neural network configurations for testing. Without any loss of generality, two MLPs were evaluated with configurations 784-10, and 784-100-10, and call them N1 and N2. For both networks, three sets of experiments I, II, and III were conducted. Experiment I corresponded to a network without any countermeasure. Experiment II corresponded to the network with the countermeasure blocks present, but the randomness is disabled. Essentially all the random values are fixed to −1 in every measurement. In a way, the approach emulated the test used in previous masking-based solutions. Experiment III corresponded to the network with countermeasures enabled by actually changing the randomness for each measurement. The goal was to quantify the amount of side-channel leakage in 1) a vanilla neural network with no defense, 2) a network with additional logic for defense but disabled randomness, and 3) the final solution with defense enabled. TVLA was used as the testing metric.

FIG. 3 shows averaged power consumption and TVLA results on N1 from the experiments. The t-scores were observed to cross the threshold of ±4.5 for all three experiments. However, the magnitude of t-scores decreases from I to III. The t scores are highest in I because of the lack of any defense; the image is processed directly with the same parameters for each inference causing a high information leakage. The t scores are lower in II compared to I because the noise caused by the additional logic of the defense decreases the signal-to-noise ratio in the side channel measurements. Although the defense is disabled, it still imparts some protection. The t scores reduce by approximately 2× in III. This is because of the active defense. A reduction of 50% was observed in the t-scores for III compared to II. The new inference algorithm chooses a different set of parameters for each inference based on the random input received. This leads to a decrease in the side-channel information leakage due to the reduced probability of the same parameters getting processed each time in the measurement.

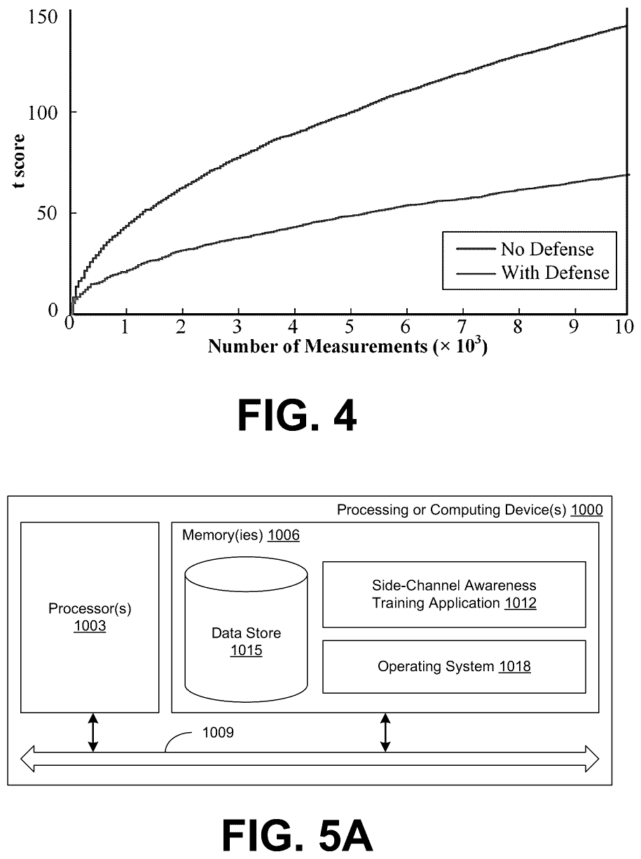

FIG. 4 shows the evolution and variation of the t scores with the increasing number of measurements (number of traces in experiment II (top) compared to III (bottom)). A TVLA was conducted with 20,000 measurements, thus, the fixed and random sets contain approximately 10,000 traces each. As the setup captures more measurements, an increasing trend was observed in the t-scores for both II and III. However, the increase is much more rapid in II compared to III. This implies that with the defense enabled, the increase in the side channel leakage with a number of measurements is substantially lower that the implementation with the defense disabled.

Accuracy Evaluations. A number of models were evaluated to validate if the proposed defense causes any accuracy loss. Table 9 presents the accuracy results. The MNIST dataset was used for all the evaluations. Three MLP networks were trained with no hidden layer, one hidden layer, and two hidden layers. All the hidden layers have 100 nodes. It was observed that the accuracy of the models with the defense stays very similar to the baseline model with no defense. There is a slight decrease in the accuracy of the layerwise models. This may be attributed to all the models being trained with the same size of training data. This causes each of the models in the layerwise defense to get lesser training data than it would have if it were trained individually. This can be fixed by training the models for a larger number of epochs.

TABLE 9
Accuracy Comparison of theModels with Defense.

| Architecture | Baseline | Modelwise | Layerwise |
|---|---|---|---|
| 784-10 | 91.98% | 91.24% | 91.52% |
| 784-100-10 | 97.35% | 97.29% | 95.89% |
| 784-100-100-10 | 97.68% | 97.47% | 96.3% |

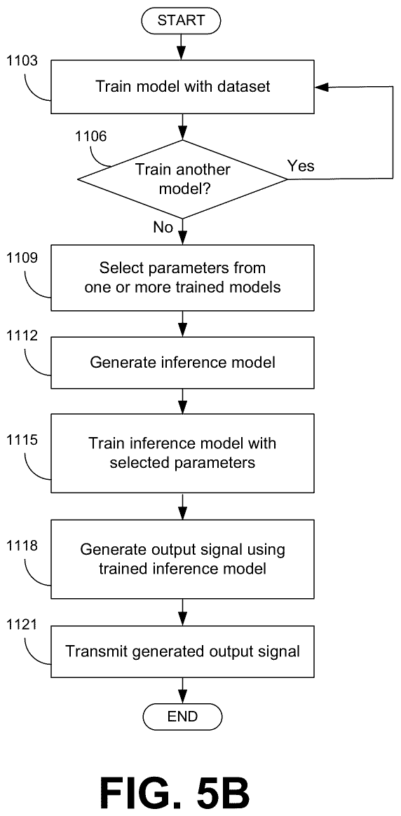

With reference next to FIG. 5A, shown is a schematic block diagram of a processing or computing device 1000. In some embodiments, among others, the computing device 1000 may represent one or more computing devices (e.g., a computer, server, Tensor Processing Unit (TPU), edge TPU, etc.). Each processing or computing device 1000 includes at least one processor circuit, for example, having a processor 1003 and a memory 1006, both of which are coupled to a local interface 1009. To this end, each processing or computing device 1000 may comprise, for example, at least one server computer or like device, which can be utilized in a cloud-based environment. The local interface 1009 may comprise, for example, a data bus with an accompanying address/control bus or other bus structure as can be appreciated.

In some embodiments, the processing or computing device(s) 1000 can include one or more network interfaces. The network interface may comprise, for example, a wireless transmitter, a wireless transceiver, and/or a wireless receiver (e.g., Bluetooth®, Wi-Fi, Ethernet, etc.). The network interface can communicate with a remote computing device using an appropriate communications protocol. As one skilled in the art can appreciate, other wireless protocols may be used in the various embodiments of the present disclosure.

Stored in the memory 1006 are both data and several components that are executable by the processor 1003. In particular, stored in the memory 1006 and executable by the processor 1003 are at least one side-channel awareness training application 1012 and potentially other applications and/or programs. Also stored in the memory 1006 may be a data store 1015 and other data. In addition, an operating system 1018 may be stored in the memory 1006 and executable by the processor 1003.

It is understood that there may be other applications that are stored in the memory 1006 and are executable by the processor 1003 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1006 and are executable by the processor 1003. In this respect, the term “executable” means a program or application file that is in a form that can ultimately be run by the processor 1003. Examples of executable programs may be, for example, a compiled program that can be translated into machine code in a format that can be loaded into a random access portion of the memory 1006 and run by the processor 1003, source code that may be expressed in proper format such as object code that is capable of being loaded into a random access portion of the memory 1006 and executed by the processor 1003, or source code that may be interpreted by another executable program to generate instructions in a random access portion of the memory 1006 to be executed by the processor 1003, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores and the memory 1006 may represent multiple memories 1006 that operate in parallel processing circuits, respectively, such as multicore systems, FPGAs, GPUs, GPGPUs, spatially distributed computing systems (e.g., connected via the cloud and/or Internet). In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, performing load balancing. The processor 1003 may be of electrical or of some other available construction.

Although the side-channel awareness training application 1012 and other applications/programs, described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the side-channel awareness training application 1012 and other applications/programs, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the side-channel awareness training application 1012 and other applications/programs, may be implemented and structured in a variety of ways. For example, one or more applications described may be implemented as modules or components of a single application. The flowchart or diagram of FIG. 5B shows an example of the architecture, functionality, and operation of a possible implementation of the side-channel awareness training application 1012. In this regard, each block can represent a module, segment, or portion of code, which comprises one or more executable instructions for implementing the specified logical function(s). It should also be noted that in some alternative implementations, the functions noted in the blocks may occur out of the order noted in FIG. 5B. For example, two blocks shown in succession in FIG. 5B may in fact be executed substantially concurrently or the blocks may sometimes be executed in a different or reverse order, depending upon the functionality involved. Alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure. Further, one or more applications described herein may be executed in shared or separate computing devices or a combination thereof. For example, a plurality of the applications described herein may execute in the same processing or computing device 1000, or in multiple computing devices in the same computing environment. Additionally, it is understood that terms such as “application,” “service,” “system,” “engine,” “module,” and so on may be interchangeable and are not intended to be limiting.

Referring next to FIG. 5B, shown is a flow chart illustrating an example of side-channel awareness training and its use, in accordance with various embodiments of the present disclosure. A plurality of trained models can be generated by stochastically training a plurality of neural network models using a common training dataset. Beginning at 1103, a neural network model can be trained using the dataset. At 1106, it is determined if another model is to be trained. If so, then the flow returns to 1103 where the next neural network model can be trained. If not, then the flow proceeds to generate an inference model. Parameters can be randomly selected from one or more of the trained models at 1109 and the inference model can be generated at 1112 based upon the selected parameters. All of the randomly selected parameters can be selected from a single trained model or the randomly selected parameters can be selected from selected from two or more trained models. Parameters associated with different layers of the inference model can be randomly selected from corresponding layers of different trained models. At 1115, the inference model can be trained with the selected parameters. An input signal can then be processed using the trained inference model to generate an output signal for transmission. For example, the output signal can be generated using the trained inference model at 1118 and transmitted at 1121.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for side-channel awareness training, comprising:
generating a plurality of trained models by stochastically training a plurality of neural network models using a common training dataset;
generating an inference model based upon random selection of parameters from one or more of the plurality of trained models; and
training the inference model with the selected parameters.

2. The method of claim 1, wherein all of the randomly selected parameters are selected from a single trained model.

3. The method of claim 1, wherein the randomly selected parameters are selected from two or more trained models.

4. The method of claim 3, wherein parameters associated with different layers of the inference model are randomly selected from corresponding layers of different trained models.

5. The method of claim 3, wherein the randomly selected parameters comprise a combination of weights and biases.

6. The method of claim 1, further comprising processing in input signal using the trained inference model to generate an output signal for transmission.

7. The method of claim 1, wherein the inference model is executed on an Edge Tensor Processing Unit (TPU).

8. The method of claim 1, wherein the plurality of trained models are trained offline.

9. A system for side-channel awareness training, comprising:
at least one processing device comprising processing circuitry, the at least one processing device configured to at least:
generate a plurality of trained models by stochastically training a plurality of neural network models using a common training dataset;
generate an inference model based upon random selection of parameters from one or more of the plurality of trained models; and
train the inference model with the selected parameters.

10. The system of claim 9, wherein all of the randomly selected parameters are selected from a single trained model.

11. The system of claim 9, wherein the randomly selected parameters are selected from two or more trained models.

12. The system of claim 11, wherein parameters associated with different layers of the inference model are randomly selected from corresponding layers of different trained models.

13. The system of claim 11, wherein the randomly selected parameters comprise a combination of weights and biases.

14. The system of claim 9, wherein the trained inference model is executed on an edge tensor processing unit (TPU).

15. The system of claim 14, further comprising processing in input signal using the trained inference model to generate an output signal for transmission.

16. The system of claim 14, wherein each of the plurality of trained models are trained offline.
